(19) United States
(12) Patent Application Publication
(10) Pub. No.: US 2009/0072993 A1
(43) Pub. Date: Mar. 19, 2009

(54) REMOTE CONTROL SYSTEM AND METHOD THEREOF

(75) Inventors: WEN-CHENG WANG, Tu-Cheng (TW); WEN-CHIN HSIEH, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/100,269

(22) Filed: Apr. 9, 2008

(30) Foreign Application Priority Data
Sep. 14, 2007 (CN) 200710201714.9

(51) Int. Cl. G05B 19/02

(52) U.S. Cl. 340/825.22

(57) ABSTRACT

An remote control system includes a remote control and a corresponding electronic device. The remote control includes a transmitter module configured for transmitting signals. The electronic device includes a user-defined module configured for setting a self-defined function code correlating a desired operation of the electronic device with a button of the remote control; and a receiver module configured for receiving the signals transmitted by the transmitter module.

### TECHNICAL FIELD

The present invention relates to electronic devices/systems with customized remote control mechanisms, and specifically, to a remote control system and method that can be adopted in an electronic device.

### BACKGROUND

Electronic devices have become a part of modern life. In order to provide the user with an easily-controlled interface for the electronic device, come with a remote control so that the user can control the electronic device from afar. The remote controls of the electronic devices often comprise buttons, which correspond to different operations of the electronic devices. A button for controlling a specific operation can make a remote control output a signal (e.g., an infrared ray or an electromagnetic signal) associated with the operation. When an electronic device receives the signal, the electronic device executes the corresponding operation.

A remote control system generally includes a remote control and an electronic device to be controlled. The remote control outputs a signal in response to an input of a user. The signal is converted into a coded signal and sent to a receiver provided in the controlled electronic device. Upon receiving the signal, the receiver decodes the coded signal triggering execution of the desired operation of the electronic device. Coding of the signal is usually determined by the manufacturer in accordance with the type of electronic device being controlled. In some cases, there is a possibility for two different devices to have a same system of coding. Thus, a problem arises when two different devices having the same coding system are used near each other. For example, an unintentional operation of one television set may occur when a remote control system for a DVD player located nearby is operated. Therefore, there is a need to develop a remote control system and method, which can distinguish signals received from an associated remote control from signals received from another device using the same coding system.

### SUMMARY

In accordance with a present embodiment, a remote control system including a remote control and a corresponding electronic device to be controlled is provided. The remote control includes a transmitter module configured for transmitting signals. The electronic device includes a user-defined module configured for setting a self-defined function code correlating a desired operation of the electronic device with a button of the remote control, and a receiver module configured for receiving the signals transmitted by the transmitter module.

Other novel features and advantages will be drawn from the following detailed description of at least one preferred embodiment, when considered in conjunction with the attached drawings.

### BRIEF DESCRIPTION OF THE DRAWINGS

Many aspects of the present remote control system and method can be better understood with reference to the following drawings. The components in the drawings are not necessarily drawn to scale, the emphasis instead being placed upon clearly illustrating the principles of the present automatic focusing system and method. Moreover, in the drawings, like reference numerals designate corresponding parts throughout the several views.

FIG. 1 is a functional block diagram of a remote control system in accordance with an exemplary embodiment;

FIG. 2 is a flow chart of a remote control method of the remote control system in FIG. 1.

### DETAILED DESCRIPTION OF THE PREFERRED EMBODIMENTS

Embodiments of the present remote control system and method will now be described in detail below and with reference to the drawings.

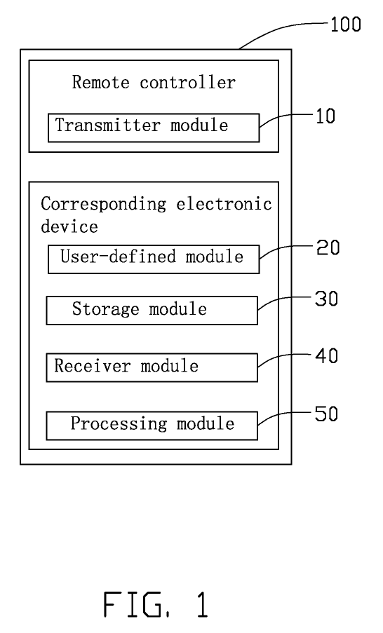

Referring to FIG. 1, a remote control system 100 in accordance with a present embodiment is shown. The remote control system 100 includes a remote control and a corresponding electronic device to be controlled. The remote control includes a transmitter module 10. The corresponding electronic device includes a user-defined module 20, a storage module 30, a receiver module 40, and a processing module 50.

The transmitter module 10 is installed inside the remote control. The remote control includes a number of buttons corresponding to different operations of the electronic device. The transmitter module 10 is configured for transmitting signals corresponding to the operations selected by a user of the remote control. The signals can be, for example, infrared. The signals include, in this embodiment, a recipient code and a defined function code. The remote control transmits a fixed recipient code to control the corresponding electronic device. The defined function code is preset and configured for controlling a specific operation of the corresponding electronic device. For example, the remote control controls a corresponding electronic device (a TV) to switch channels by transmitting a recipient code (of the TV) and a first defined function code (switch channel). Similarly, the remote control can control the TV to increase volume by transmitting the recipient code (of the TV) and a second defined function code (increase volume).

The user-defined module 20 is configured for setting a self-defined function code correlating a desired operation of the corresponding electronic device with a button of the remote control by the user. When the user-defined module 20 is activated, the corresponding electronic device displays a setting message using an on screen display (OSD) to instruct the user to set a self-defined function code corresponding to a customized operation of the corresponding device through the remote control. The self-defined function code of the customized operation of the corresponding electronic device is set to the button of the remote control defined by the user in the setup mode. For example, the corresponding electronic device enters the setup mode and prompts the user with a message on the OSD: “Please set the volume up button”. The user selects and presses a button of the remote control to associate the button with the function code “volume up”. Any previously defined function code associated with the button is thus replaced by the self-defined function code “volume up”. After exiting the setup mode, the corresponding electronic device can work in a normal mode and receive signals from the remote control and execute operations corresponding to the signals.

The storage module 30 is electrically connected to the user-define module 20. The storage module 30 is configured for storing both the preset recipient code and the defined function code of the transmitter module 10. Preferably, the storage module 30 is an electrically erasable programmable read only memory (EEPROM).

The receiver module 40 is configured for receiving the signals transmitted from the transmitter module 10. The processing module 50 is electrically connected to the receiver module 40 and the storage module 30. The processing module 50 is configured for determining whether the recipient code of the signal received by the receiver module 40 is identical to that stored in the storage module 30. If the recipient code received by the receiver module 40 is identical to the recipient code stored in the storage module 30, the corresponding electronic device responds by executing a corresponding operation according to the defined function code of the button pressed. Updating of the defined function code of the buttons on the remote control allows users to effectively prevent unintentional execution of operations of different electronic devices having a same recipient code when they are near each other. If the recipient code received by the receiver module 40 is not identical to that stored in the storage module 30, the corresponding electronic device ignores the received signal.

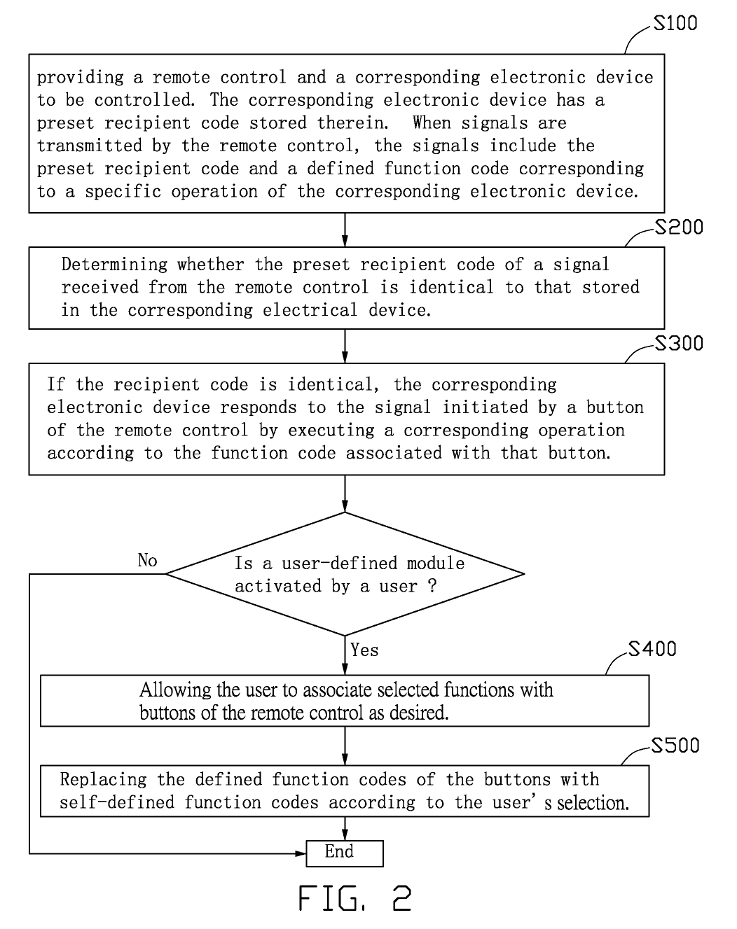

Referring to FIG. 2, a remote control method provided in the remote control system 100 includes:

S100: providing a remote control and a corresponding electronic device to be controlled. The corresponding electronic device has a preset recipient code stored therein. When signals are transmitted by the remote control, the signals include the preset recipient code and a defined function code corresponding to a specific operation of the corresponding electronic device.
S200: Determining whether the preset recipient code of a signal received from the remote control is identical to that stored in the corresponding electrical device.
S300: If the recipient code is identical, the corresponding electronic device responds to the signal initiated by a button of the remote control by executing a corresponding operation according to the function code associated with that button.
S400: When a user-defined module is activated by a user, allowing the user to associate selected functions with buttons of the remote control as desired;
S500: Replacing the defined function codes of the buttons with self-defined function codes according to the user's selection.

It will be understood that the above particular embodiment and method are described and shown in the drawings by way of illustration only. The principles and features of the present invention may be employed in various and numerous embodiments thereof without departing from the scope of the invention as claimed. The above-described embodiment illustrates the scope of the invention but does not restrict the scope of the invention.

What is claimed is:

1. A remote control system, comprising:
a remote control comprising a transmitter module configured for transmitting signals having a recipient code and a defined function code;
a corresponding electronic device to be controlled, the electronic device comprising:
a user-defined module configured for setting a self-defined function code correlating a desired operation of the electronic device with a button of the remote control; and
a receiver module configured for receiving the signals transmitted by the transmitter module.

2. The remote control system as claimed in claim 1, wherein when the user-defined module is activated, the corresponding electronic device displays a setting message using an on screen display for setting the self-defined function code correlating with the button through the remote control.

3. The remote control system as claimed in claim 2, wherein the self-defined function code of the desired operation of the corresponding electronic device is set to the button of the remote control.

4. The remote control system as claimed in claim 2, wherein any previously defined function code associated with the button is thus replaced by the self-defined function code.

5. The remote control system as claimed in claim 1, wherein the remote control system further comprises a storage module configured for storing the signal.

6. The remote control system as claimed in claim 5, wherein the remote control system further comprises a processing module configured for determining whether the signal received by the receiver module is identical to that stored in the storage module.

7. The remote control system as claimed in claim 6, wherein if the signal received by the receiver module is identical to that stored in the storage module, the electronic device responds to the remote control by executing the desired operation according to the self-defined function code of the button.

8. The remote control system as claimed in claim 6, wherein the processing module is electrically connected to the receiver module and the storage module.

9. A remote control method comprising:
providing a remote control and a corresponding electronic device to be controlled, the corresponding electronic device having a preset recipient code; the remote control transmitting signals having the preset recipient code and a defined function code corresponding to a specific operation of the corresponding electronic device;
allowing a user to associate selected functions with buttons of the remote control as desired when a user-define module is activated by the user; and
replacing the defined function codes of the buttons with self-defined function codes according to the user's selection.

10. The remote control method as claimed in claim 9, further comprising:
providing a storage module configured for storing the preset recipient code of the corresponding electronic device and the defined function code.

11. The remote control method as claimed in claim 10, further comprising:
determining whether the preset recipient code of a signal received from the remote control is identical to that stored in the corresponding electrical device; and if the recipient code is identical, the corresponding electronic device responds to the signal initiated by a button of the remote control by executing a corresponding operation according to the function code associated with that button;

12. The remote control method as claimed in claim 11, wherein when the user-defined module is activated, the corresponding electronic device displays a setting message using an on screen display to instruct the user to set the self-defined function code corresponding to a customized operation of the corresponding device through the remote control.
